(19) United States
(12) Patent Application Publication
(10) Pub. No.: US 2025/0206149 A1
(43) Pub. Date: Jun. 26, 2025

(54) Boost Mode of a Motor Vehicle With an Electric Drive Machine

(71) Applicant: Bayerische Motoren Werke Aktiengesellschaft, Muenchen (DE)

(72) Inventors: Florian SCHNAPPAUF, Hattenhofen (DE); Thomas WAGNER, Reichertshausen (DE)

(21) Appl. No.: 18/844,084

(22) PCT Filed: Mar. 21, 2023
(86) PCT No.: PCT/EP2023/057199

§ 371 Date: Sep. 5, 2024

(30) Foreign Application Priority Data
Apr. 26, 2022 (DE) 10 2022 110 032.4

(51) Int. Cl. B60L 15/20

(52) U.S. Cl. CPC B60L 15/209; B60L 2240/423; B60L 2250/28; B60L 2260/167; B60L 2260/26; B60L 2270/42

(57) ABSTRACT

The present disclosure relates to a longitudinal guidance device for a motor vehicle with an electric drive machine, having a control unit, which can be coupled to the drive machine in order to actuate a drive torque, and a boost switch, which can be coupled to the control unit in order to request an additional drive torque, wherein the control unit is designed to actuate a higher drive torque while the boost switch is actuated until a maximum boost torque is reached and/or until the actuation of the boost switch ends.

### BACKGROUND AND SUMMARY

The present disclosure relates to a device and a method for the longitudinal guidance of a motor vehicle with an electric drive machine.

In vehicles powered by an internal combustion engine, the desired driving torque specified by the driver via an accelerator pedal is usually calculated by an engine control unit as a function of the respective accelerator pedal position. The accelerator pedal characteristic is described by a map stored in the control unit. This accelerator pedal characteristic maps the driver's desired torque as a function of the accelerator pedal position, for example in the form of an accelerator pedal characteristic curve. Here, for example, a factor is determined from the characteristic map, on the basis of which the desired engine torque is calculated in the control unit and engine control variables such as the amount of fuel and/or air to be supplied and/or a corresponding ignition angle are determined on this basis.

It is also known to provide a manual switchover function in vehicles powered by an internal combustion engine, wherein the driver can switch to a sport mode by manually actuating a command transmitter. In sport mode, the system switches to sport-tuned maps in which the driver's request is also determined as a function of the accelerator pedal angle and engine speed and a corresponding control signal is determined to control the internal combustion engine. The only difference between the sport-tuned maps and those for normal operation is that higher torque specifications are generated and forwarded to the internal combustion engine even with shorter pedal travel.

Corresponding maps are also known for motor vehicles powered by an electric drive machine. In some cases, maps are used that simulate the specific characteristics of internal combustion engine operation.

In general, the maps used for normal operation do not fully exploit the possible spread of acceleration characteristics when operating electric machines in motor vehicles.

So-called boost modes are therefore known, in which an accelerator pedal characteristic is used of which the accelerator pedal characteristic curve assigns a higher drive torque to a certain accelerator pedal position than in normal operation. However, even the known boost modes do not fully exploit the possible spread of acceleration characteristics when operating electric machines in motor vehicles.

Against this background, it is an object of the invention to improve the longitudinal guidance of an electrically powered motor vehicle.

Each of the independent claims defines with its features a subject matter which achieves this object. The dependent claims relate to advantageous embodiments of the invention.

According to one aspect, there is disclosed a longitudinal guidance device for a motor vehicle having at least one electric drive machine.

The longitudinal guidance device further comprises: (a) a control unit which can be coupled to the drive machine in order to actuate a drive torque while the motor vehicle is being driven; and/or (b) a boost switch which can be coupled to the control unit in order to request an additional drive torque starting from a normal driving state, wherein the starting point for requesting the additional drive torque is a normal operation drive torque which can be predetermined and/or is predetermined by means of an accelerator pedal, in particular by means of a position of the accelerator pedal, in particular on the basis of an accelerator pedal characteristic; and/or (c) according to one embodiment, an accelerator pedal with an accelerator pedal position, wherein a drive torque to be actuated, in particular by means of the control unit, is assigned to the accelerator pedal position in normal operation, in particular by means of an accelerator pedal characteristic.

The control unit is set up to actuate an ever-increasing drive torque during an actuation of the boost switch, in particular for the entire uninterrupted duration, at least until a maximum boost torque is reached and/or until the end of actuation of the boost switch occurs.

In the present case, an ever-increasing drive torque is to be understood in particular as a temporal drive torque development in which a greater drive torque is actuated at each later point in time than at each earlier point in time.

This allows a boost experience for the vehicle occupants, and especially for the driver, to be embodied as a continuous, more immersive driving experience.

According to a further aspect, there is disclosed a method for longitudinal guidance of a motor vehicle having at least one electric drive machine, in particular by means of a longitudinal guidance device according to one embodiment of the invention, said method comprising at least the following method steps, which can be carried out in the specified or another proper sequence: (i) detecting a continuous boost switch actuation; and/or (ii) actuating an increasingly greater drive torque during the detected boost switch actuation until a maximum boost torque is reached and/or until an end of actuation of the boost switch occurs.

The invention is based, among other things, on the consideration that known boost modes do not utilize the acceleration possibilities of powerful electric drive machines, and thus there is still room for a more emotional, immersive driving experience.

The invention is based, among other things, on the following idea: when the driver switches to boost mode (by pressing a boost switch such as a boost paddle or button), there is an initial drive torque jump from the normal mode accelerator pedal progression, from which the driver activates the boost, to the boost accelerator pedal progression by means of a proportionally, digitally blended accelerator pedal characteristic curve.

If the driver then keeps the boost switch pulled or pressed, the accelerator pedal characteristic curve continues to compress or fades continuously to the boost accelerator pedal progression until boost mode is ended after a period of a few seconds, for example, or is deactivated due to other dropping criteria. This is followed by a release or a fade back to normal mode (accelerator pedal progression from which the driver had switched to boost). The continuous sharpening of the accelerator pedal progression and the release can also be staged by a recorded sound and an adapted display on the display and operation unit.

The term accelerator pedal characteristic is also understood here to refer to that part of a more complex accelerator pedal characteristic that defines the relationship between the accelerator pedal position (in particular in the sense of an angular and/or displacement deflection) and a drive torque to be actuated as part of the accelerator pedal characteristic. Of course, the accelerator pedal characteristic can also take into account other operating parameters such as the engine speed when assigning the drive torque, which may then be recorded together with the dependency on the accelerator pedal position in a more complex accelerator pedal map.

According to one embodiment, the control unit is set up to trigger a jump in drive torque at the start of actuation of the boost switch. In particular, the control unit is set up to trigger the drive torque jump so quickly that it is not perceived by vehicle occupants as a drive torque gradient, but as a jolt. This means that boost mode can be initiated with a driving behavior that—at least in its immediacy with actuation of the boost switch—can only be achieved with electric motor drives and can therefore be an exciting feature.

According to one embodiment, the control unit is set up to control a continuous drive torque gradient, in particular a continuous increase in drive torque, at the beginning of the actuation of the boost switch or following a drive torque step. This makes it possible to achieve a driving behavior that creates a continuously more immersive driving experience with longer actuation of the boost switch and thus enables an increasingly stronger perception of the vehicle occupants during the entire boost operation (or at least until a maximum boost drive torque is reached).

According to one embodiment, the maximum boost torque is greater than the maximum drive torque in normal operation (i.e. without actuating the boost switch). This allows the boost experience to be further intensified.

According to one embodiment, the control unit is set up to preset the boost torque in accordance with an accelerator pedal characteristic with a boost accelerator pedal characteristic curve which is distorted on the basis of a normal operation accelerator pedal characteristic curve, wherein the normal operation accelerator pedal characteristic curve defines a relationship between an accelerator pedal position and a drive torque to be controlled for a specific accelerator pedal position in normal operation.

According to one embodiment, the boost accelerator pedal characteristic curve is distorted based on the normal operating accelerator pedal characteristic curve in that, when the boost switch is actuated:
(I) without a perceptible time delay, i.e. in particular with the actuation of the boost switch, the normal operation accelerator pedal characteristic is compressed abruptly along the pedal position axis, i.e., with a jump in compression, so that a jump in the drive torque is triggered, in particular with a constant pedal position; and/or
(II) without a perceptible time delay, i.e. in particular with the actuation of the boost switch, the normal operation accelerator pedal characteristic is stretched along the drive torque axis, so that, in particular with the pedal position remaining constant, a maximum normal operation drive torque is replaced by a higher, maximum boost torque; and/or
(III) after the initial jump with further actuation of the boost switch, the normal operating accelerator pedal characteristic is continuously compressed further along the pedal position axis, in particular starting from the normal operating accelerator pedal characteristic compressed in accordance with the compression jump.

This means that a boost mode according to the invention can be realized in a low-computation manner on a conventional control unit and/or an implementation of the invention does not require any elaborate operation of an additional, independent boost accelerator pedal characteristic—instead, only the normal operating accelerator pedal characteristic is suitably distorted.

According to one embodiment, the control unit is set up to actuate boost mode at a constant accelerator pedal position. This allows the driver to perceive the boost effect even more clearly.

According to one embodiment, the control unit is set up to actuate boost mode in partial load operation, in particular with a slight deflection of the accelerator pedal. This allows the type of boost operation according to the invention to have the greatest effect on the vehicle occupants, because the drive torque increases for longer until the maximum boost torque is reached.

In particular, up to an accelerator pedal position of 50% or 35% of the maximum accelerator pedal deflection, this can be referred to as partial load operation.

According to one embodiment, the control unit is set up to provide the vehicle occupants with a boost sound production during boost operation, in particular a drive sound at full load and/or an aircraft take-off sound and/or a ticking clock sound, in particular to play the boost sound production on the hi-fi system or another sound generator of the motor vehicle. This can further enhance the boost experience of the vehicle occupants.

According to one embodiment, the control unit is set up to return to normal operation when the boost switch is no longer actuated, in particular by equalizing the accelerator pedal characteristics, in particular immediately or gradually within a fraction of a second or within one or a few seconds.

According to one embodiment, the end of actuation of the boost switch occurs independently of its actuation by the expiry of a maximum boost time. The maximum boost time can be 5 or 10 or 15 seconds, for example. This ensures that the drive is not overloaded.

According to one embodiment, the control unit is set up to provide the vehicle occupants with an end-of-boost sound at the end of boost operation, in particular an air blast and/or an extension of an aircraft landing gear, in particular to play the end-of-boost sound on the hi-fi system or another sound generator of the vehicle. This allows the boost experience of the vehicle occupants to be further differentiated from normal operation.

### BRIEF DESCRIPTION OF THE DRAWINGS

Further advantages and possible applications of the invention can be found in the following description in conjunction with the figures:

FIG. 1 schematically shows a longitudinal guidance device according to an exemplary embodiment of the invention in an electrically drivable motor vehicle;

FIG. 2 shows an accelerator pedal characteristic for the longitudinal guidance device from FIG. 1 using a normal operation accelerator pedal characteristic and a boost accelerator pedal characteristic, each of which defines a relationship between an accelerator pedal position and a drive torque to be actuated;

FIG. 3 shows a graph of the longitudinal guidance device from FIG. 1 showing the development of drive torque over time during boost operation using the boost accelerator pedal characteristic curve from FIG. 2.

### DETAILED DESCRIPTION OF THE DRAWINGS

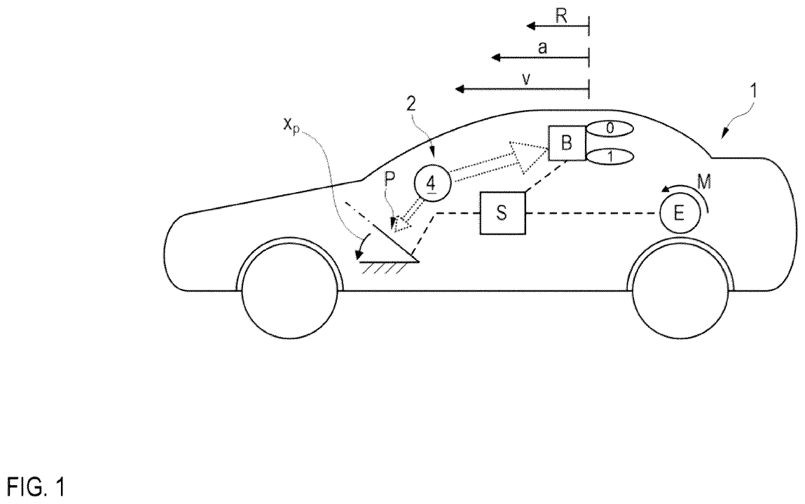

FIG. 1 shows a longitudinal guidance device 2 for a motor vehicle 1 with an electric drive machine E, by means of which a longitudinal guidance driver request 4 of a vehicle driver can be implemented.

To input the longitudinal guidance driver's request 4, the longitudinal guidance device 2 has an accelerator pedal P for entering a normal mode driver request and a boost switch B for entering a boost mode driver request. The boost switch can, for example, be a pushbutton or, as in the present case, a pullable paddle, in particular arranged on a steering wheel of the motor vehicle.

To implement the longitudinal guidance driver request 4 entered by means of the accelerator pedal P and the boost switch B, the longitudinal guidance device 2 has a control unit S which can be coupled to the accelerator pedal P and the boost switch B for reading out the respective driver requests 4 entered and to the drive machine E for actuating a drive torque M when the motor vehicle is being driven.

The boost switch B can be coupled with the control unit S for requesting an additional drive torque, starting from a normal driving operation, wherein the starting point for requesting the additional drive torque is a normal operation drive torque, which is predetermined by means of a position x_P of the accelerator pedal P on the basis of a normal operation accelerator pedal characteristic.

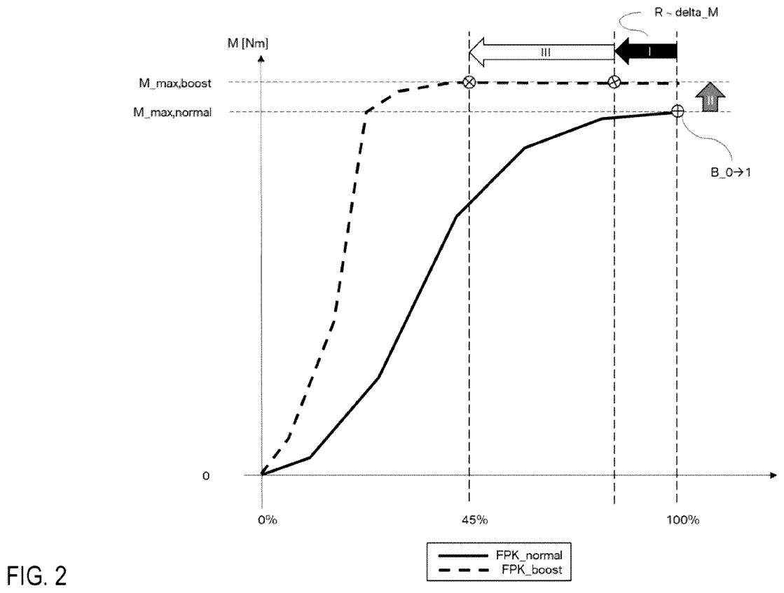

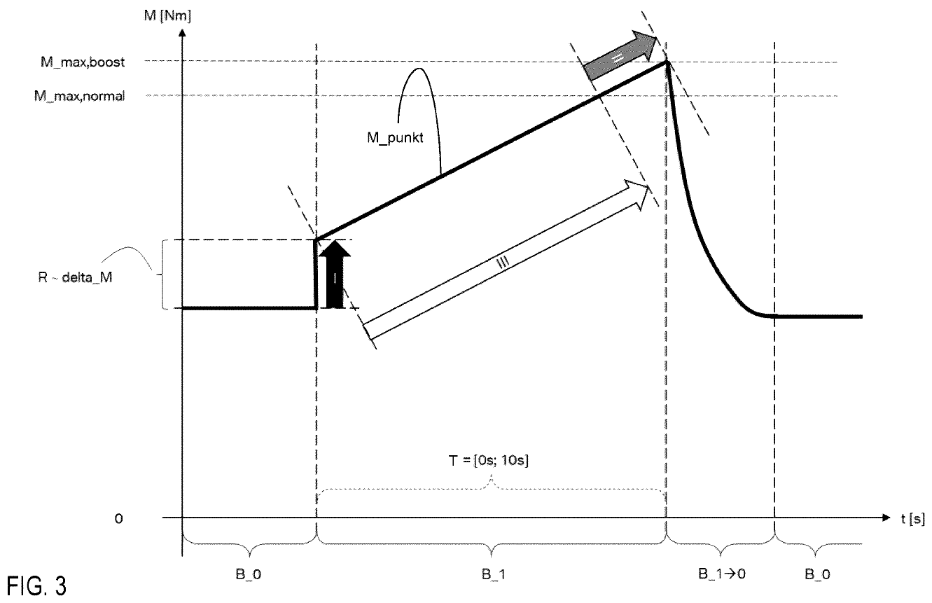

In order to enable an exemplary boost operation, as shown in FIGS. 2 and 3, in an exemplary method for longitudinal guidance of the motor vehicle 1, a boost switch actuation B_1 is detected and an increasingly greater drive torque M is applied during the detected boost switch actuation. The drive torque increases from the start of the boost switch actuation B_1 until either a maximum boost torque M_max, boost is reached and/or until an actuation end B_0 of the boost switch B occurs. The end of actuation B_0 of the boost switch B can occur by removing the operation of the switch or independently of its actuation by the expiry of a maximum boost time. This allows a boost experience for the vehicle occupants, and in particular for the driver, to be embodied as a continuous, more immersive driving experience.

When actuation B_1 of the boost switch B begins, the control unit S triggers a drive torque jump delta_M. This drive torque jump delta_M results in a massive forward jerk R and is illustrated by an arrow I in the graphs in FIGS. 2 and 3.

The boost accelerator pedal characteristic curve FPK_boost is distorted starting from the normal operation accelerator pedal characteristic curve FPK_normal, in that the normal operation accelerator pedal characteristic curve FPK_normal jumps along the pedal position axis x_P at the start of actuation B_1 of the boost switch B without a perceptible time delay, i.e., with a jump in compression (arrow I in FIG. 2), so that a jump delta_M in the drive torque M is triggered, particularly if the pedal position x_P remains constant.

The control unit S can control the drive torque jump delta_M so quickly that it is not perceived by the vehicle occupants as a gradual drive torque gradient, but as a single jerk R. This means that boost mode can be initiated with a driving behavior that—at least in its immediacy when the boost switch is actuated—can only be achieved with electric motor drives and can therefore be an exciting feature.

In addition, the normal operation accelerator pedal characteristic curve FPK_normal is stretched along the drive torque axis M (see arrow II) without a perceptible time delay when the boost switch is actuated, so that a maximum normal operation drive torque M_max, normal is replaced by a higher, maximum boost torque M_max, boost, particularly if the pedal position remains constant. The maximum boost torque M_max, boost is, for example, 10% greater than the maximum drive torque M_max, normal in normal operation, which takes place without actuation of the boost switch B.

This can further intensify the boost experience.

Immediately after the drive torque jump delta_M and the associated jerk R, the control unit S controls a continuous drive torque gradient M_punkt of the drive torque M. The course of the drive torque M is continuously defined during this continuous increase; however, the continuous drive torque gradient M_punkt does not have to be constant (even if this is shown in FIG. 3).

After the drive torque jump delta_M, the normal operating accelerator pedal characteristic curve FPK_normal is continuously compressed further along the pedal position axis x_P with further actuation of the boost switch B (cf. arrow III), starting from the normal operating accelerator pedal characteristic curve compressed according to the compression jump.

This makes it possible to achieve a driving behavior that creates a continuously more immersive driving experience with longer actuation of the boost switch B and thus enables an increasingly stronger perception of the vehicle occupants during the entire boost operation (or at least until a maximum boost drive torque is reached).

This means that the boost mode according to the invention can be realized in a low-computation manner on a conventional control unit and/or the implementation of the invention does not require any elaborate operation of an additional, independent boost accelerator pedal characteristic—instead, only the normal operating accelerator pedal characteristic is suitably distorted.

FIG. 3 shows a boost mode with a constant accelerator pedal position in partial load operation with a slight deflection of the accelerator pedal. Here, the vehicle driver can perceive the boost effect even more clearly because he does not assign the increase in drive torque M to an accelerator pedal actuation. This means that the type of boost operation according to the invention can have the clearest effect on the vehicle occupants because the drive torque increases for longer until the maximum boost torque is reached.

At the end of actuation B_0 of the boost switch, the normal operating accelerator pedal characteristic FPK_normal is actuated again within a few seconds by means of equalization of the boost accelerator pedal characteristic FPK_boost in a relief phase B_1->0 (see FIG. 3).

In the exemplary embodiment, the end of actuation B_0 occurs automatically after a maximum boost time T of 10 seconds has elapsed. This ensures that the drive is not overloaded.

### LIST OF REFERENCE SIGNS

motor vehicle 1

longitudinal guidance device 2

longitudinal guidance driver request 4

boost switch B

actuation of the boost switch B_1

actuation end of the boost switch B_0

electric drive machine E

normal operation accelerator

pedal characteristic FPK_normal

boost accelerator pedal characteristic FPK_boost

accelerator pedal characteristic K

accelerator pedal characteristic maps K1, K2

drive torque M

maximum boost drive torque M_max, boost

maximum normal operating drive torque M_max, normal

drive torque gradient M_punkt

drive torque jump delta_M

accelerator pedal P

jerk R

control unit S

time T

accelerator pedal position x_P

distortions of the driving pedal

characteristic line (arrows) I, II, III

1-13. (canceled)

14. A longitudinal guidance device for a motor vehicle with an electric drive machine, comprising:
a control unit which can be coupled to the drive machine to control a drive torque; and
a boost switch which can be coupled to the control unit to request an additional drive torque;
wherein the control unit is configured to actuate an ever-increasing drive torque during an actuation of the boost switch until at least one of a maximum boost torque is reached or until an end of actuation of the boost switch occurs.

15. The longitudinal guidance device as claimed in claim 14, wherein:
the control unit is configured to control a drive torque jump at a beginning of the actuation of the boost switch.

16. The longitudinal guidance device as claimed in claim 14, wherein:
the control unit is configured to control a continuous drive torque gradient of the drive torque at a beginning of the actuation of the boost switch or subsequently to a drive torque step.

17. The longitudinal guidance device as claimed claim 14, wherein:
a maximum boost torque is greater than a maximum drive torque in normal operation.

18. The longitudinal guidance device as claimed in claim 14, wherein:
the control unit is configured to predetermine the boost torque according to a boost accelerator pedal characteristic curve which is distorted starting from a normal operation accelerator pedal characteristic curve.

19. The longitudinal guidance device as claimed in claim 18, wherein:
the boost accelerator pedal characteristic curve is distorted on the basis of the normal operating accelerator pedal characteristic curve in that, when the boost switch is at least one of:
the normal operation accelerator pedal characteristic is abruptly compressed along the pedal position axis without a perceptible time delay;
the normal operation accelerator pedal characteristic is stretched along the drive torque axis (M) without a perceptible time delay; or
after the initial jump (delta_M) with further actuation of the boost switch, the normal operation accelerator pedal characteristic is continuously further compressed along the pedal position axis.

20. The longitudinal guidance device as claimed in claim 14, wherein:
the control unit is configured to control the boost operation at a constant accelerator pedal position.

21. The longitudinal guidance device as claimed in claim 14, wherein:
the control unit is configured to control the boost mode in a partial load mode where a small deflection of the accelerator pedal occurs.

22. The longitudinal guidance device as claimed in claim 14, wherein:
the control unit is configured to provide the vehicle occupants with a boost sound staging during boost operation.

23. The longitudinal guidance device as claimed in claim 22, wherein the boost sound comprises at least one of a drive sound at full load, a sound of an aircraft take-off, or a sound of a ticking clock.

22. The longitudinal guidance device as claimed in claim 14, wherein:
the control unit is configured to return to normal operation at an actuation end of the boost switch.

23. The longitudinal guidance device as claimed in claim 22, wherein the actuation end of the boost switch comprises an equalization of the accelerator pedal characteristic.

24. The longitudinal guidance device as claimed in claim 14, wherein:
an end of actuation of the boost switch takes place independently of its actuation by the expiry of a maximum boost time period.

25. The longitudinal guidance device as claimed in claim 14, wherein:
the control unit is configured to provide the vehicle occupants with an end-of-boost sound staging.

26. The longitudinal guidance device as claimed in claim 25, wherein the end-of-boost stound staging comprise at least one of an air ejection or an extension of an aircraft landing gear.

27. A method for longitudinal guidance of a motor vehicle with an electric drive machine, in particular by means of a longitudinal guidance device as claimed in claim 14, the method comprising:
detecting a continuous boost switch actuation; and
actuating an ever-increasing drive torque during the detected boost switch actuation until at least one of a maximum boost drive torque is reached or an end of actuation of the boost switch occurs.
